(19) United States
(12) Patent Application Publication
(10) Pub. No.: US 2004/0048971 A1
(43) Pub. Date: Mar. 11, 2004

(54) Epoxy resin composition for semiconductor encapsulation

(76) Inventors: Atsuhito Hayakawa, Yokkaichi (JP); Yasuyuki Murata, Yokkaichi (JP)

Correspondence Address: RESOLUTION PERFORMANCE PRODUCTS LLC, ATTN: LISA JONES, 1600 SMITH STREET, P.O. BOX 4500, HOUSTON, TX, 77210-4500, US

(21) Appl. No.: 10/250,605

(22) PCT Filed: Jan. 8, 2002
(86) PCT No.: PCT/NL02/00008

(30) Foreign Application Priority Data
Jan. 19, 2001 (JP) 2001/11383

(51) Int. Cl. C08K 3/34

(52) U.S. Cl. 524/492; 524/493

(57) ABSTRACT

The present provides an epoxy resin composition for semiconductor encapsulation, which has a low melt viscosity, is excellent in storage stability and moldability, and gives a cured product having excellent solder crack resistance. Said epoxy resin composition comprises, as essential components: (a) as an epoxy resin, a biphenol type epoxy resin represented by general formula (I) (where R¹-R⁸ represent hydrogen, an alkyl group, a phenyl group, an aralkyl group, or an alkoxyl group, and n is 0-5); (b) as a phenol type hardener, a thiodiphenol compound represented by general formula (II) and a polyhydric phenol compound having a structure other than the thiodiphenol compound (where X represents an alkyl group, a phenyl group, an aralkyl group, or an alkoxyl group, and m is 0-3); (c) an inorganic filler, and (d) a curing accelerator.

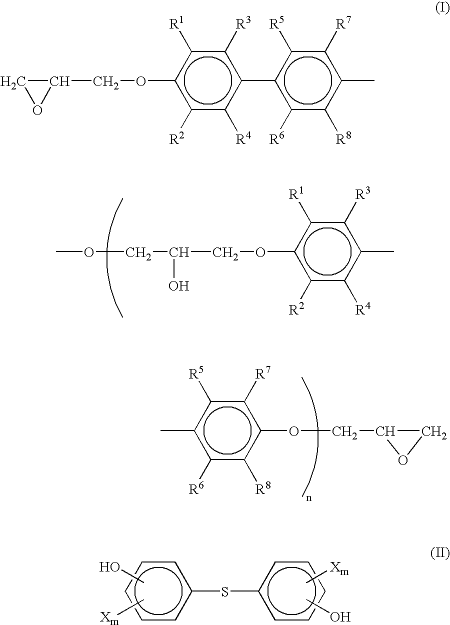

The present invention relates to an epoxy resin composition for semiconductor encapsulation, which has a low melting viscosity, and has an excellent storage stability and moldability, and which gives a cured product having excellent solder crack resistance.

Epoxy resin compositions are widely used for adhesion, casting, encapsulation, larmination, molding, coating and the like because of its excellent curing properties and easy handling. Further,there are various kinds of epoxy resins, and curing properties greatly vary depending on its selection. For those reasons, epoxy resins are used properly in accordance with the purpose of use.

However, in recent years, various characteristics required of polymeric materials become strict as the use conditions of the polymeric materials become severe, and in various epoxy resins generally used, the required characteristics cannot sufficiently be satisfied.

For example, epoxy resin compositions are used for semiconductor encapsulation, but the required performances become strict even in this field. That is, a high degree of integration of semiconductor devices proceeds, resulting in a large-sized semiconductor element and also a small-sized and thin package. Further, the mounting technology of the semiconductor device is transfering to surface mounting. In surface mounting, in particular, a semiconductor device is directly dipped in a solder bath, and therefore exposed to high temperature. As a result, a large stress is applied to the entire package due to a rapid expansion of the absorbed moisture, and this stress causes cracks in an encapsulant. For this reason, an epoxy resin composition for a semiconductor encapsulation having good solder crack resistance is required to have a low moisture absorption and low stress properties.

It is widely conducted to improve the low moisture absorption and low stress properties (that is, low modulus of elasticity) by highly filing an inorganic filler such as a fused silica powder, and this is greatly effective to the improvement of the solder crack resistance. However, if the inorganic filler is highly filled, its fluidity at the time of molding is impaired. Therefore, it has also been required for an epoxy resin for an encapsulant to have a low melt viscosity.

Further, with advancement of package miniaturization and the package becoming thiner, high fluidity is also required of an epoxy resin composition for encapsulation, and the requirement of low melt viscosity to the epoxy resin becomes severer.

Further, moldability (that is, rapid curability) is also strongly required in order to increase a molding cycle from the standpoint of productivity improvement of the semiconductor devices, and the reality is that materials not having rapid curability, even though having other good properties, are not used.

Compositions for encapsulantion comprising a blend of cresol novolak type epoxy resins and phenolic resins, are mainly used at present, and are excellent in rapid curability. However, it can no longer be said that they are sufficient in low moisture absorption and low melt viscosity.

In recent years, it is widely studied to use a biphenyl type epoxy resin of a low melt viscosity (Japanese Patent Application Laid-open No. Sho 61-47725), and such a resin is already put into practical use. In the case of using this epoxy resin, such properties as low moisture absorption, low stress or the like may be improved. However, when formulated with a conventional hardener, the rapid curability is insufficient, and this is a great productivity problem.

An added amount of a curing accelerator in the composition can be increased in order to improve the curability, but in this case, storage stability as an encapsulant deteriorates, an is therefore not practical.

As described above, it has been generally difficult to realize moldability and solder crack resistance with a good balance in an epoxy resin composition for semiconductor encapsulation.

The present invention has an object to provide an epoxy resin composition for semiconductor encapsulation, which has a low melt viscosity and is also excellent having in low moisture absorption and low stress properties, thereby giving a cured product having excellent solder crack resistance and moldability.

As a results of extensive research and experimentation there has now surprinsingly been found that the object can be achieved by combining a biphenol type epoxy resin excellent in low moisture absorption and low stress properties, and thiodiphenol compound and polyhydric phenol compound as a phenol type hardener.

Accordingly, the present invention relates to:

An epoxy resin composition for semiconductor encapsulation, comprising, as essential components

(a) as an epoxy resin, a biphenol type epoxy resin represented by general formula (I):

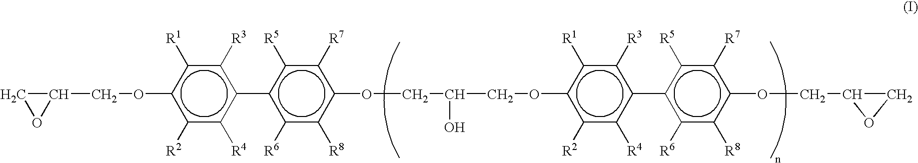

(where R¹-R⁸ may each be the same or different, and represent hydrogen, an alkyl group having 1-12 carbon atoms, a substituted or unsubstituted phenyl group, a substituted or unsubstituted aralkyl group, or an alkoxyl group, and n is a number of 0-5 on the average value);

(b) as a hardener,

(b-1) a thiodiphenol compound represented by general formula (II)

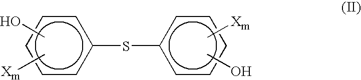

in an amount of 1-90% by weight in component (b): (where X may each be the same or different and represents an alkyl group having 1-12 carbon atoms, a substituted or unsubstituted phenyl group, a substituted or unsubstituted aralkyl group, or an alkoxyl group, and m may each be the same or different and is an integer of 0-3);

(b-2) a polyhydric phenol compound having a structure other than component (b-1), in an amount of 10-99% by weight in component (b);

(c) an inorganic filler in an amount of 75-95% by weight of the entire composition; and (d) a curing accelerator.

More in particular the invention relates to an epoxy resin composition for semiconductor encapsulation, is characterized in that as the epoxy resin (a), the biphenol type epoxy resin represented by R¹=R²=R⁷=R⁸=CH₃, and R³=R⁴=R⁵=R⁶=H in the general formula (I) is used.

In a special embodiment of said epoxy resin composition for semiconductor encapsulation, is characterized in that as the epoxy resin (a), the biphenol type epoxy resin obtained by reacting one mole of 3,3′,5,5′-tetramethyl-4,4′-biphenol with 5-30 moles of an epihalohydrin in the presence of an alkali metal hydroxide is used.

A more special embodiment of the here in before defined epoxy resin composition for semiconductor encapsulation, is characterized in that as the epoxy resin (a), the biphenol type epoxy resin mixture obtained by reacting a mixture of 4,4′-biphenol and 3,3′,5,5′-tetramethyl-4,4′-biphenol with an epihalohydrin in an amount of 3-15 moles per one mole of phenolic hydroxyl groups of the mixture of the said phenol compounds in the presence of an alkali metal hydroxide is used.

A preferred epoxy resin composition for semiconductor encapsulation, is characterized in that as the thiodiphenol compound (b-1), at least one kind of thiodiphenol compound selected from the group consisting of bis(4-hydroxyphenyl)sulfide, bis(4-hydroxy-3-methylphenyl)sulfide, bis(4-hydroxy-3,5-dimethylphenyl)sulfide and bis(4-hydroxy-3-tert-butyl-6-methylphenyl)sulfide is used.

A more preferred embodiment of the epoxy resin composition for semiconductor encapsulation, is characterized in that as the polyhydric phenol compound (b-2), at least one kind of polyhydric phenol compound selected from the group consisting of phenol novolak resin, phenol aralkyl resin, terpene phenolic resin, dicyclopentadiene phenolic resin and naphthol novolak resin is used.

A more preferred embodiment of the epoxy resin composition for semiconductor encapsulation, is characterized in that as the inorganic filler (c), crushed type and/or spherical, fused silica powder and/or crystalline silica powder is contained in an amount of 83-93% by weight of the entire composition.

Most preferably the epoxy resin composition for semiconductor encapsulation, is characterized in that as the curing accelerator (d), at least one kind of curing accelerator selected from the group consisting imidazoles, amines, organic phosphorous compounds, and their salts is used.

The epoxy resin (a) used in the epoxy resin composition for semiconductor encapsulation of the present invention is not particularly limited so long as it is an epoxy resin represented by the above general formula (I), and includes, for example, epoxy resins obtained by reacting 4,4′-dihydroxybiphenyls with an epihalohydrin in the presence of an alkali metal hydroxide.

Examples of 4,4′-dihydroxybiphenyls as a raw material for producing the biphenol type epoxy resin include 4,4′-biphenol, 3,3′-dimethyl-4,4′-biphenol, 3,5-dimethyl-4,4′-biphenol, 3,5-dibutyl-4,4′-biphenol, 3,3′-diphenyl-4,4′-biphenol, 3,3′,5,5′-tetramethyl-4,4′-biphenol, 3,3′-dimethyl-5,5′-dibutyl-4,4′-biphenol and 3,3′,5,5′-tetrabutyl-4,4′-biphenol.

Those 4,4′-dihydroxybiphenyls may be used alone or as mixtures thereof as a raw material for producing the epoxy resin. Of those, 4,4′-biphenol and 3,3′,5,5′-tetramethyl-4,4′-biphenol are preferable from the point of curing properties.

Reaction of those 4,4′-dihydroxybiphenyls and an epihalohydrin is conducted by conventional known methods, and a representative embodiment thereof is described in detail below.

First, 4,4′-Dihydroxybiphenyls are dissolved in an epihalohydrin in an amount corresponding to 3-15 moles per mole of phenolic hydroxyl group in 4,4′-dihydroxybiphenyls to prepare a homogeneous solution. While stirring the solution, an alkali metal hydroxide in an amount of 0.9-2 moles per mole of phenolic hydroxyl groups is added thereto in the form of a solid or an aqueous solution to conduct reaction. This reaction can be conducted under ordinary or reduced pressure, and the reaction temperature is generally about 30-105° C. in the case of the reaction under ordinary pressure and about 30-80° C. in the case of the reaction under reduced pressure. The reaction is conducted such that water is removed from a reaction system by returning an oily component of condensate to the system which is obtained by cooling volatilized vapor followed by oil/water reparation and water withdrawal, while,if necessary, using azeotrope under maintaining the reaction temperature at a defined one. The alkali metal hydroxide is added intermittently or continuously in small portions over 1-8 hours in order to suppress rapid reaction. The overall reaction time is generally about 1-10 hours.

After completion of the reaction, insoluble salts by-produced are removed by filtration or removed by water washing, and unreacted epihalohydrin is then removed by distillation under reduced pressure, thereby the desired epoxy resin is obtained

Epichlorohydrin or epibromohydrin is generally used as the epihalohydrin in this reaction. Further, NaOH or KOH is generally used as the alkali metal hydroxide.

Further, the reaction may use a catalyst, for example, quaternary ammonium salts such as tetramethylammonium chloride or tetraethylammonium bromide; tertiary amines such as benzyldimethylamine, 2,4,6-tris(dimethylaminomethyl)phenol; imidazoles such as 2-ethyl-4-methylimidazole or 2-phenylimidazole; phosphonium salts such as ethyltriphenylphosphonium iodide; and phosphines such as triphenylphosphine.

Further, the reaction may use an inert organic solvent, for example, alcohols such as ethanol or 2-propanol, ketones such as acetone or methyl ethyl ketone; ethers such as dioxane or ethylene glycol dimethyl ether; glycol ethers such as methoxypropanol; and aprotic polar solvents such as dimethylsulfoxide or dimethylformamide.

In the case that the amount of saponified halogen of the epoxy resin obtained above is large, the epoxy resin can be re-treated to obtain a purified epoxy resin having sufficiently decreased amount of saponified halogen. That is, the crude epoxy resin is re-dissolved in an inert organic solvent such as 2-propanol, methyl ethyl ketone, methyl isobutyl ketone, toluene, xylene, dioxane, methoxypropanol or dinethylsulfoxide, the alkali metal hydroxide is added thereto in the form of a solid or an aqueous solution, and recyclization reaction is conducted at a temperature of about 30-120° C. for 0.5-8 hours. Thereafter, excess alkali metal hydroxide or salts by-produced are removed by a method such as water washing, and the organic solvent is distilled off under reduced pressure, thereby a purified epoxy resin is obtained.

Further, in order to maintain a low melt viscosity of the biphenol type epoxy resin and sufficiently obtain the effect of the present invention, it is preferable that n in the general formula (I) is n=0-0.2.

The epoxy resin derived from 3,3′,5,5′-tetramethyl-4,4′-biphenol is commercially available as, for example, Epikote YX4000 (trade name, a product of Japan Epoxy Resins Co., Ltd.), and a mixed epoxy resin of an epoxy resin derived from 4,4′-biphenol and an epoxy resin derived from 3,3′,5,5′-tetramethyl4,4′-biphenol is commercially available as, for example, YL6121H. The present invention may be practiced using those commercially available products.

Further, in the present invention, in order to control handling properties or curing properties of the composition, the aforementioned biphenol type epoxy resin can be used by mixing other epoxy resin therewith.

Examples of other epoxy resins that can be mixed include epoxy resins produced from various phenols (e.g., bisphenol A, bisphenol F, bisphenol AD, bisphenol S, thiodiphenol, hydroquinone, methylhydroquinone, dibutylhydroquinone, resorcin, methylresorcin, dihydroxydiphenylether, thiodiphenol, dihydroxynaphthalene, etc.) or polyhydric phenolic resins obtained by polycondensation reaction of various phenols and various aldehydes (e.g., hydroxybenzaldehyde, crotonealdehyde, glyoxal, etc.), and an epihalohydrin; epoxy resins produced by various amine compounds such as diaminodiphenylmethane, aminophenol or xylenediamine, and an epihalohydrin; and epoxy resins produced from various carboxylic acids such as methylhexahydroxyphthalic acid or dimer acid, and an epihalohydrin.

The amount of other epoxy resins used is preferably 100 parts by weight or less, more preferably 50 parts by weight or less, per 100 parts by weight of the biphenol type epoxy resin. If the amount of other epoxy resins used is too large, the effect of the present invention is not sufficiently exhibited.

The thiodiphenol compound (b-1) is compounded, as one component of the phenol type hardener, with the epoxy resin composition for semiconductor encapsulation of the present invention. The thiodiphenol compound is not limited so long as it has the structure represented by the aforementioned general formula (II). Examples of the compound include bis(4-hydroxyphenyl)sulfide, bis(2-hydroxyphenyl) sulfide, 2-hydroxyphenyl-4′-hydroxyphenylsulfide, bis(4-hydroxy-3-methylphenyl)sulfide, bis(4-hydroxy-3,5-dimethylphenyl)sulfide, bis(4-hydroxy-2-methyl-5-tert-butylphenyl)sulfide, bis(4-hydroxy-3-methyl-5-tert-butylphenyl)sulfide, bis(4-hydroxy-3-tert-butyl-6-methylphenyl)sulfide, and bis(4-hydroxy-3,5-di-tert-butylphenyl)sulfide.

From easy availability and curing properties, bis(4-hydroxyphenyl)sulfide, bis(4-hydroxy-3-methylphenyl)sulfide, bis(4-hydroxy-3,5-dimethylphenyl)sulfide and bis(4-hydroxy-3-tert-butyl-6-methylphenyl)sulfide are preferable, and bis(4-hydroxyphenyl)sulfide is more preferable.

As another component (b-2) of the phenol type hardener (b), conventional known compounds can be used as the polyhydric phenol compound having the structure other than the component (b-1), and examples thereof include various phenolic resins such as polyhydric phenolic resins obtained by condensation reaction of polyhydric phenols (e.g., bisphenol A, bisphenol F, bisphenol S, hydroquinone, resorcin, biphenol, tetramethylbiphenol, dihydroxynaphthalene, dihydroxydiphenyl ether, phenol novolak resin, cresol novolak resin, bisphenol A novolak resin, naphthol novolak resin, etc.) or various phenols, and various aldehydes (e.g., benzaldehyde, hydroxybenzaldehyde, crotonealdehyde, glyoxal, etc.); and modified phenolic resins obtained by polycondensation reaction of phenol aralkyl resin, phenol terpene resin, dicyclopentadiene phenolic resin, heavy oils or pitches, phenols and aldehyde compound.

From moldability and solder crack resistance, phenol novolak resin, phenol aralkyl resin, terpene phenolic resin, dicyclopentadiene phenolic resin and naphthol novolak resin are preferable, and phenol aralkyl resin is more prefereable.

Those polyhydric phenol compounds (b-2) may be used alone or as mixtures of two kinds or more.

In the phenol type hardener (b) that is the essential component in the epoxy resin composition for semiconductor encapsulation of the present invention, the proportion of each component used is 10-99% by weight of the polyhydric phenol compound (b-2) having the structure other than component (b-1) to 1-90% by weight of the thiodiphenol compound (b-1). If the thiodiphenol compound (b-1) is less than 1% by weight, curability decreases, so that sufficient moldability is not obtained. If it is more than 90% by weight, mechanical properties (strength and the like) of the cured product obtained become insufficient From the balance of the above various properties, the use proportion of component (b-1) and component (b-2) is preferably 30-97% by weight of (b-2) to 3-70% by weight of (b-1), more preferably 45-95% by weight of (b-2) to 5-55% by weight of (b-1).

Hardeners other than the phenol type hardener (b) can be mixed with the epoxy resin composition for semiconductor encapsulation of the present invention. Examples of the hardener that can be mixed include acid anhydrides such as methyltetrahydrophthalic anhydride, hexahydrophthalic anhydride, pyromellitic anhydride or methylnadic acid; amines such as diethylenetriamine, isophoronediamine, diaminodiphenylmethane, diaminodiphenylsulfone or dicyandiamide; and activated ester compounds obtained by esterifying, such as benzoating or acetating, the whole or part of phenolic hydroxyl groups in various phenol compounds exemplified in the examples of the phenol type hardener (b).

The amount of those other hardeners used is preferably 50% by weight or less to the total amount of phenol type hardeners. If the use amount of the hardener other than the epoxy resin hardener of the present invention is too much, the effect of the present invention is not sufficiently exhibited.

Each component of those hardeners may be used by previously mixing to prepare a mixed hardener, or mixed with various components when producing the epoxy resin composition, each component of the hardener for epoxy resin may separately be added and then simultaneously mixed together.

The use amount of the hardener used is such that the amount of groups that react with epoxy groups in the entire hardeners is preferably 0.5-2.0 moles, more preferably 0.7-1.2 moles, per mole of epoxy groups in the entire epoxy resin components.

The inorganic filler component (c) is blended with the epoxy resin composition for semiconductor encapsulation of the present invention. Examples of the inorganic filler include fused silica, crystalline silica, glass powder, alumina and calcium carbonate. The shape thereof is a crushed form or a spherical form. Various inorganic fillers are used alone or as mixtures of two kinds or more. Of those, fused silica or crystalline silica is preferable. The amount of the inorganic filler used is 75-95% by weight, more preferably 83-93% by weight, of the entire composition.

If the amount of the inorganic filler of component (c) is too small, the improvement effect of low moisture absorption is small, resulting in poor solder crack resistance. If the amount of the inorganic filler (c) is too much, its fluidity in molding is impaired because of not having low melt viscosity.

The curing accelerator (d) used in the epoxy resin composition for semiconductor encapsulation of the present invention is a compound that accelerates reaction between epoxy groups in the epoxy resin and active groups in the hardener.

Examples of the curing accelerator include phosphine compounds such as tributyl phosphine, triphenyl phosphine, tris(dimethoxyphenyl)phosphine, tris(hydroxypropyl)phosphine and tris(cyanoethyl)phosphine; phosphonium salts such as tetraphenyl phosphonium tetraphenyl borate, methyl tribbutylphosphonium tetraphenyl borate and methyl tricyanoethyl phosphonium tetraphenyl borate; imidazoles such as 2-methyl imidazole, 2-phenyl imidazole, 2-ethyl-4methyl imidazole, 2-undecyl imidazole, 1-cyanoethyl-2-methyl imidazole, 2,4-dicyano-6-[2-methyl imidazolyl-(1)]-ethyl-S-triazine and 2,4-dicyano-6-[2-undecyl imidazolyl-(1)]-ethyl-S-triazine; imidazolium salts such as 1-cyanoethyl-2-undecylimidazolium trimellitate, 2-methylimidazolium isocyanurate, 2-ethyl-4-methylimidazolium tetraphenyl borate and 2-ethyl-1,4-dimethylimidazolium tetraphenyl borate; amines such as 2,4,6-tris(dimethylaminomethyl)phenol, benzyl dimethylamine, tetramethylbutyl guanidine, N-methyl piperazine and 2-dimethylamino-1-pyrroline; ammonium salts such as triethylammoniumtetraphenyl borate; diazabicyclo compounds such as 1,5-diazabicyclo(5,4,0)-7-undecene, 1,5-diazabicyclo(4,3,0)-5-nonene and 1,4-diazabicyclo(2,2,2)octane; and tetraphenyl borates, phenol salts, phenol novolak salts and 2-ethylhexanoic acid salts of those diazabicyclo compounds. Of the compounds used as those curing accelerators, phosphine compounds, imidazole compounds, diazabicyclo compounds and their salts are preferable.

Various additives can be blended with the epoxy resin composition for semiconductor encapsulation of the present invention, similar to other general epoxy resin compositions. Examples of such various additives include coupling agents, flame retardants, plasticizers, reactive diluents and pigments. Those can appropriately be blended according to the need.

Examples of the flame retardant include halogen type flame retardants such as brominated epoxy resin and brominated phenolic resin; antimony compounds such as antimony trioxide; phosphorus type flame retardants such as phosphoric acid esters and phosphines; nitrogen type flame retardants such as melamine derivatives; and inorganic flame retardants such as aluminum hydroxide and magnesium hydroxide.

However, recently, from the standpoint of deterioration of characteristics or environmental protection, it is desirable to not blend the above-mentioned flame retardants. Since the cured product of the epoxy resin composition for semiconductor encapsulation of the present invention has excellent flame retardancy, it is not necessary to blend those flame retardants, or it is possible to decrease the flame retardants used to a small amount.

The epoxy resin composition for semiconductor encapsulation of the present invention has low melt viscosity, is excellent in storage stability and moldability, and gives a cured product having excellent solder crack resistance, and therefore can advantageously be used in the field of semiconductor encapsulation.

Moreover these epoxy compositions show in a cured state a flame-retardation property, without the use of halogenated compounds.

### EXAMPLE

Production examples of the components for epoxy resin composition for semiconductor encapsulation of the present invention, and examples and comparative examples of the epoxy resin composition for semiconductor encapsulation of the present invention are shown below.

### Production Example 1 of Biphenyl Type Epoxy Resin of Component (a)

200 g of 3,3′,5,5-tetramethyl-4,4′-biphenol, 917 g of epichlorohydrin and 357 g of 2-propanol were charged in a 3 liters four-necked flask equipped with a thermometer, a stirring device and a cooling pipe, and temperature in the system was elevated to 40° C. Thereafter, 157 g of 48.5 wt % sodium hydroxide aqueous solution was added dropwise over 90 minutes. During the addition, temperature was gradually elevated such that the system reached 65° C. after completion of the dropwise addition. The system was maintained at 65° C. for 30 minutes to complete reaction, and salts by-produced and excess sodium hydroxide were removed by water washing. Excess epichlorohydrin and 2-propanol were distilled off from the reaction product under reduced pressure to obtain a crude epoxy resin.

This crude epoxy resin was dissolved in 683 g of methyl isobutyl ketone, 10 g of 48.5 wt % sodium hydroxide aqueous solution was added thereto, and reaction was conducted at a temperature of 65° C. for 1 hour. Thereafter, monosodium phosphate was added to the reaction mixture to neutralize excess sodium hydroxide, followed by water washing to remove salts by-produced. Methyl isobutyl ketone was completely removed under reduced pressure to obtain 286 g of the desired epoxy resin. The epoxy resin obtained had an epoxy equivalent of 186 g/eq., and a viscosity at 150° C. of 0.2P.

### Production Example 2 of Biphenyl Type Epoxy Resin of Component(a)

90 g of 4,4′-biphenol, 100 g of 3,3′,5,5′-tetramethyl-4,4′-biphenol, 995 g of epichlorohydrin and 387 g of 2-propanol were charged, reaction was conducted in the same manner as in Production Example 1 to obtain 281 g of the desired epoxy resin. The epoxy resin obtained had an epoxy equivalent of 171 g/eq., and a viscosity at 150° C. of 0.1P.

### Epoxy Resin Composition Examples 1-6 and Comparative Examples A-C

The epoxy resin and orthocresol novolak resin type epoxy resin produced in Production Examples 1 and 2 as the biphenyl type epoxy resin; phenol novolak resin, phenol aralkyl resin, naphthol aralkyl resin, dicyclopentadiene phenolic resin and terpene phenolic resin as the hardener; tetrabromobisphenol A type epoxy resin as the brominated epoxy resin; silica powder as the inorganic filler; triphenylphosphine as the curing accelerator; antimony trioxide as the flame retardant; epoxysilane as the coupling agent; and carnauba wax as the release agent were respectively used as shown in Table 1 to formulate each epoxy resin composition.

The proportions of the thiodiphenol compound (b-1) and the polyhydric phenol compound (b-2) in the phenol type hardener (b) in Example 1 are 5% by weight and 95% by weight, respectively, those in Example 2 are 10% by weight and 90% by weight, respectively, those in Example 3 are 20% by weight and 80% by weight, respectively, those in Example 4 are 30% by weight and 70% by weight, respectively, those in Example 5 are 40% by weight and 60% by weight, respectively, and those in Example 6 are 60% by weight and 40% by weight, respectively.

Each blend was melt kneaded at a temperature of 70-120° C. for 5 minutes using a mixing roll. Each molten mixture obtained was taken out in the form of thin sheet, and the sheet was cooled and then pulverized to obtain each molding material. Each molding material was molded with a low pressure transfer molding machine at a mold temperature of 175° C. and a molding time of 180 seconds to obtain each test piece, and each test piece was post-cured at 180° C. for 8 hours. Further, spiral flow was measured in order to examine fluidity and storage stability of each molding material, and gel time and hot hardness at mold releasing were measured in order to examine moldability of each molding material.

Further, moisture absorption, modulus of elasticity and flame retardancy of each test piece after post-curing were tested. Furthermore, solder crack resistance of a dummy semiconductor device encapsulated with each molding material was tested. All of those results are shown in Table 1.

TABLE 1
Examples 1-6 and Comparative Examples A-C of Epoxy Resin Composition

| Epoxy Resin Composition | | | | | | | | Comparative | Comparative | Comparative |
|---|---|---|---|---|---|---|---|---|---|---|
| Formulation (parts by weight) | | Example 1 | Example 2 | Example 3 | Example 4 | Example 5 | Example 6 | Example A | Example B | Example C |
| | Epoxy resin | Production | Production | Production | Production | Production | Production | Production | Production | A (*1) |
| | | Example 1 | Example 1 | Example 1 | Example 1 | Example 1 | Example 2 | Example 1 | Example 1 | |
| | Compounding amount | 100 | 100 | 100 | 100 | 100 | 100 | 100 | 100 | 100 |
| | Brominated epoxy resin | | | | | | | | | |
| | (*11) | | | | | | | | | |
| | Compounding amount | 0 | 0 | 0 | 0 | 0 | 0 | 0 | 0 | 8 |
| | Thiodiphenol compound | B (*2) | C (*3) | C | C | D (*4) | D | | | |
| | Compounding amount | 3 | 9 | 19 | 26 | 32 | 49 | | | |
| | Other polyhydric phenol | E (*5) | F (*6) | G (*7) | H (*8) | I (*9) | J (*10) | F | G | E |
| | compound | | | | | | | | | |
| | Compounding amount | 53 | 80 | 75 | 62 | 47 | 33 | 89 | 107 | 51 |
| | Inorganic filler (*12) | 898 | 1081 | 1108 | 1078 | 1026 | 1129 | 1080 | 1183 | 966 |
| | Triphenylphosphine | 1 | 1 | 1 | 1 | 1 | 1 | 1 | 2 | 1 |
| | Antimonytrioxide | 0 | 0 | 0 | 0 | 0 | 0 | 0 | 0 | 9 |
| | Carnauba wax | 1 | 1 | 1 | 1 | 1 | 1 | 1 | 1 | 1 |
| | Silane coupling agent | 1 | 1 | 1 | 1 | 1 | 1 | 1 | 1 | 1 |
| | (*13) | | | | | | | | | |
| | Carbon black | 1 | 1 | 1 | 1 | 1 | 1 | 1 | 1 | 1 |
| Test | Storage stability | | | | | | | | | |
| Results | Spiral flow retention | 90 | 84 | 85 | 88 | 90 | 92 | 84 | 64 | 86 |
| | (%) (*14) | | | | | | | | | |
| | Moldability | | | | | | | | | |
| | Gel time (seconds) | 73 | 78 | 81 | 79 | 85 | 85 | 90 | 88 | 55 |
| | Hot hardness at mold | 88 | 85 | 81 | 83 | 81 | 83 | 68 | 79 | 84 |
| | releasing (*15) | | | | | | | | | |
| | Fluidity | | | | | | | | | |
| | Spiral flow (cm) | 84 | 93 | 89 | 85 | 90 | 89 | 90 | 87 | 65 |
| | Curing properties | | | | | | | | | |
| | Moisture absorption | 0.36 | 0.35 | 0.31 | 0.33 | 0.32 | 0.34 | 0.35 | 0.30 | 0.42 |
| | (%) (*16) | | | | | | | | | |
| | Modulus of elasticity | 2100 | 1950 | 1960 | 2010 | 1880 | 1890 | 2160 | 2100 | 2340 |
| | (kg/mm²) | | | | | | | | | |
| | Solder crack | 0/16 | 0/16 | 0/16 | 0/16 | 0/16 | 0/16 | 3/16 | 0/16 | 16/16 |
| | resistance (*17) | | | | | | | | | |
| | Flame retardancy (*18) | V-O | V-O | V-O | V-O | V-O | V-O | Completely | Completely | V-O |
| | | | | | | | | burned | burned | |

*1: A; Cresol novolak type epoxy resin (Epikote 180S62, trade name of Japan Epoxy Resins Co., Ltd., epoxy equivalent: 210 g/eq.)
*2: B; Bis(4-hydroxy-3-tert-butyl-6-methylphenyl)-Sulfide
*3: C; Bis(4-hydroxy-3-methylphenyl)sulfide
*4: D; Bis(4-hydroxyphenyl)sulfide
*5: E; Phenol novolak resin (Resitop PSM4261, trade name of Gun-ei Kagaku K.K., hydroxyl equivalent: 103 g/eq., softening point: 85° C.
*6: F; Phenol aralkyl resin (MEH7800S, trade name of Meiwa Plastics Ind. Ltd., hydroxyl equivalent: 170 g/eq., softening point: 71° C)
*7: G; Phenol aralkyl resin (MEH7851S, trade name of Meiwa , Plastics Ind. Ltd., hydroxyl equivalent: 205 g/eq., softening point: 73° C.)
*8: H; Naphthol aralkyl resin (MEH7810, trade name of Meiwa, Plastics Ind. Ltd., hydroxyl equivalent: 210 g/eq., softening point: 86° C.)
*9: I; Dicyclopentadiene phenolic resin (DPP-M, trade name of Nippon Petrochemical Co., hydroxyl equivalent: 170 g/eq., softening point: 95° C.)
*10: J; Terpene phenolic resin (Epicure MP402, trade name of Japan Epoxy Resins Co., Ltd., hydroxyl equivalent: 175 g/eq., softening point: 125° C.)
*11: Brominated epoxy resin (Epikote 5050, trade name of Japan Epoxy Resins Co., Ltd., epoxy equivalent: 385 g/eq., bromine content: 48%)
*12: Spherical fused silica powder (ELSIL BF100, trade name of Nippon Aerosil Co.)
*13: Epoxysilane (KBM-403, trade name of Shin-Etsu Chemical Industry Co.)
*14: Retention of spiral flow of composition treated for 96 hours under environment of 25° C. and 50% RH
*15: Measured with Shore D
*16: Moisture absorption after treatment at 85° C., 85% RH and 300 hours
*17: 16 specimens (80 pin QFP) were subjected to moisture absorption at 85° C. and 85% RH for 300 hours, and then dipped in a solder bath at 260° C. for 10 seconds. The number of cracked specimens was counted.
*18: UL94

As is apparent from Table 1, each molding material of Examples 1-6 is excellent in balance of storage stability (i.e., high spiral flow retention), fluidity (i.e., high spiral flow), moldability (i.e., high hot hardness at mold releasing), moisture resistance (i.e., a low moisture absorption), and low stress (i.e., low modulus of elasticity), and is also excellent in solder crack resistance, as compared with the molding materials of Comparative Examples A-C. Further, each molding material of Examples 1-6 does not contain a harmful halogen type flame retardant, and is excellent in flame retardancy.

The epoxy resin composition for semiconductor encapsulation of the present invention has a low melt viscosity, is excellent in storage stability and moldability, and gives a cured product having excellent solder crack resistance, and therefore can advantageously be used in the field of semiconductor encapsulation.

1. An epoxy resin composition for semiconductor encapsulation, comprising as essential components:
(a) as an epoxy resin, a biphenol type epoxy resin represented by general formula (I): 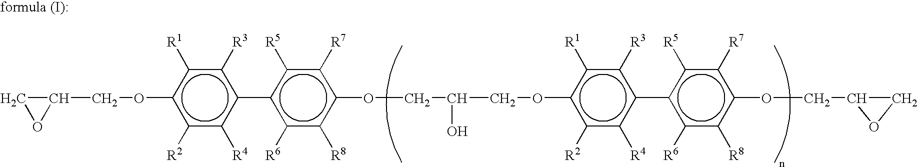
(where R¹-R⁸ may each be the same or different, and represent hydrogen, an alkyl group having 1-12 carbon atoms, a substituted or unsubstituted phenyl group, a substituted or unsubstituted aralkyl group, or an alkoxyl group, and n is a number of 0-5 on the average value);
(b) as a phenol type hardener,
(b-1) a thiodiphenol compound represented by general formula (II) 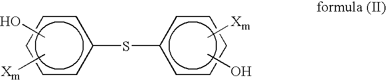
in an amount of 1-90% by weight in component (b):(where X each may be the same or different and represents an alkyl group having 1-12 carbon atoms, a substituted or unsubstituted phenyl group, a substituted or unsubstituted aralkyl group, or an alkoxyl group, and m may each be the same or different and is an integer of 0-3);
(b-2) a polyhydric phenol compound having a structure other than component (b-1), in an amount of 10-99% by weight in component (b);
(c) an inorganic filler in an amount of 75-95% by weight of the entire composition; and
(d) a curing accelerator.

2. The epoxy resin composition for semiconductor encapsulation as claimed in claim 1, characterized in that as the epoxy resin (a), the biphenol type epoxy resin represented by R¹=R²=R⁷=R⁸=CH₃, and R³=R⁴=R⁵=R⁶=H in the formula(I) is used.

3. The epoxy resin composition for semiconductor encapsulation as claimed in claim 1 or 2, characterized in that as the epoxy resin (a), the biphenol type epoxy resin obtained by reacting one mole of 3,3′,5,5′-tetramethyl-4,4′-biphenol with 5-30 moles of an epihalohydrin in the presence of an alkali metal hydroxide is used.

4. The epoxy resin composition for semiconductor encapsulation as claimed in claim 1 or 2, characterized in that as the epoxy resin (a), the biphenol type epoxy resin mixture obtained by reacting a mixture of 4,4′-biphenol and 3,3′,5,5′-tetramethyl4,4′-biphenol with an epihalohydrin in an amount of 3-15 moles per one mole of phenolic hydroxyl groups of the mixture of the phenol compounds in the presence of an alkali metal hydroxide is used.

5. The epoxy resin composition for semiconductor encapsulation as claimed in any one of claims 1 to 4, characterized in that as the thiodiphenol compound (b-1), at least one kind of thiodiphenol compound selected from the group consisting of bis(4-hydroxyphenyl)sulfide, bis(4-hydroxy-3-methylphenyl)sulfide, bis(4-hydroxy-3,5-dimethylphenyl)sulfide and bis(4-hydroxy-3-tert-butyl-6-methylphenyl)sulfide is used.

6. The epoxy resin composition for semiconductor encapsulation as claimed in any one of claims 1 to 5, characterized in that as the polyhydric phenol compound (b-2), at least one kind of polyhydric phenol compound selected from the group consisting of phenol novolak resin, phenol aralkyl resin, terpene phenolic resin, dicyclopentadiene phenolic resin and naphthol novolak resin is used.

7. The epoxy resin composition for semiconductor encapsulation as claimed in any one of claims 1 to 6, characterized in that as the inorganic filler (c), crushed type and/or spherical, fused silica powder and/or crystalline silica powder is contained in an amount of 83-93% by weight of the entire composition.

8. The epoxy resin composition for semiconductor encapsulation as claimed in any one of claims 1-7, characterized in that as the curing accelerator (d), at least one kind of curing accelerator selected from the group consisting of imidazoles, amines, organic phosphorous compounds, and their salts is used
